(19) United States
(12) Patent Application Publication
(10) Pub. No.: US 2022/0312227 A1
(43) Pub. Date: Sep. 29, 2022

(54) METHOD AND PROGRAM FOR SYNCHRONIZING USER CONFIGURATION BETWEEN DIFFERENT DEVICES

(71) Applicant: ARRIS Enterprises LLC, Suwanee, GA (US)

(72) Inventor: Yanming ZHAO, Shenzhen, Guangdong (CN)

(21) Appl. No.: 17/292,170

(22) PCT Filed: Jun. 19, 2020
(86) PCT No.: PCT/CN2020/097031

§ 371 Date: May 7, 2021

(51) Int. Cl. H04W 24/02; H04L 41/0806; H04L 41/084; H04L 41/0853; H04L 41/22; H04L 12/66

(52) U.S. Cl. CPC H04W 24/02; H04L 41/0806; H04L 41/0846; H04L 41/0853; H04L 41/22; H04L 12/66; H04W 88/16

(57) ABSTRACT

A method for synchronizing at least one device setting between a first gateway device and a second gateway device includes accessing a graphical user interface (GUI) for the first gateway device on a client device, establishing a network connection between the first gateway device and the second gateway device, obtaining a prior user configuration of device settings from the second gateway device, parsing the device settings of the second gateway device, selecting, via the GUI for the first gateway device, at least one of the device settings of the second gateway device to obtain a new user configuration, and transmitting the new user configuration to the first gateway device for implementation.

### TECHNICAL FIELD

The subject matter of the present disclosure relates generally to the implementation of operations for synchronizing a user configuration of settings between different electronic devices such as modem or gateway devices.

### BACKGROUND

Wireless networks for providing services to client devices or end devices via a modem or gateway device are prevalent in many homes and businesses. Additionally, there can be several modems or gateway devices deployed in the home or business to enhance quality of service (QoS) in the network.

However, when upgrading to a newer modem so as to replace an older modem, a user configuration of device settings of the older modem cannot be easily transferred to the newer modem.

Existing solutions are incompatible across different modem models or different modem generations and therefore require extensive manual reconfiguration of the newer modem based on the prior configuration of the older modem. For example, if an older modem (e.g., a modem with an Intel® Puma™ 6 chipset) is upgraded to a newer modem (e.g., a modem with an Intel® Puma™ 7 chipset), all of the device settings previously configured by the user in the older modem must be manually imported one by one into the newer modem.

Thus, it would be advantageous and an improvement over existing solutions to provide a method and a program for synchronizing a user configuration of settings between different electronic devices such as modem or gateway devices even if the electronic devices are different models or of different generations.

### SUMMARY

An embodiment of the present disclosure provides a method for synchronizing at least one device setting between a first gateway device and a second gateway device. The method comprises: accessing a graphical user interface (GUI) for the first gateway device on a client device; establishing a network connection between the first gateway device and the second gateway device; obtaining a prior user configuration of device settings from the second gateway device; parsing the device settings of the second gateway device; selecting, via the GUI for the first gateway device, at least one of the device settings of the second gateway device to obtain a new user configuration; and transmitting the new user configuration to the first gateway device for implementation.

The method may further comprise selecting, via the GUI for the first gateway device, a type of the network connection. The network connection may be a Wi-Fi connection or a wired Ethernet connection. Establishing the network connection between the first gateway device and the second gateway device may include scanning for a service set identifier (SSID) or obtaining an Internet Protocol (IP) address. The method may further comprise monitoring a port of one of the first gateway device or the second gateway device for the wired Ethernet connection, verifying permission to access the second gateway device or rebooting the first gateway device. The device settings may include at least one of an SSID setting, a Dynamic Domain Name Server (DDNS) setting, a parental control setting, a Wi-Fi setting or a firewall setting.

An embodiment described in the present disclosure provides a non-transitory computer-readable recording medium for synchronizing at least one device setting between a first gateway device and a second gateway device. The non-transitory computer-readable recording medium stores one or more programs which when executed by a hardware processor performs the steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system for synchronizing a user configuration of settings between different electronic devices according to an embodiment of the present disclosure;

FIG. 2 is a more detailed schematic diagram of a first modem/gateway device, a second modem/gateway device, and a client device in the system for synchronizing a user configuration of settings between different electronic devices according to an embodiment of the present disclosure;

FIG. 3 illustrates a method and algorithm for synchronizing a user configuration of settings between different electronic devices according to an embodiment of the present disclosure; and

FIG. 4 illustrates a method and algorithm of background operations for synchronizing a user configuration of settings between different electronic devices according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

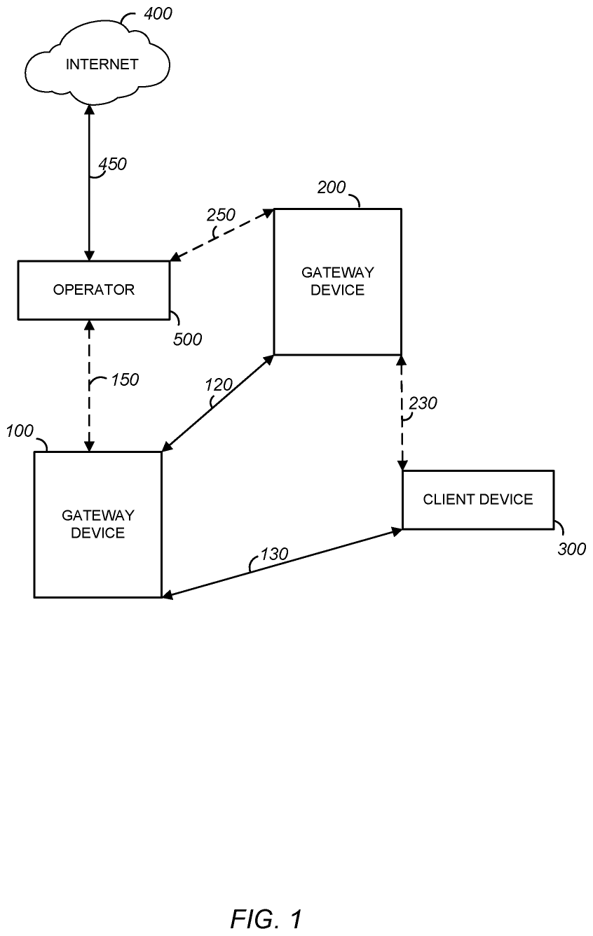

FIG. 1 is a schematic diagram of a system for synchronizing at least one setting between a first modem/gateway device 100 and a second modem/gateway device 200 according to an embodiment of the present disclosure. As shown in FIG. 1, the system includes a first modem/gateway device 100 normally connected to an operator 500 via a WAN connection 150. The WAN connection 150 constructively provides access to the Internet 400. In FIG. 1, the WAN connection 150 is turned off. The first modem/gateway device 100 is connected to a second modem/gateway device 200 via connection 120 (e.g., a Wi-Fi connection or a wired Ethernet connection) and a client device 300 via connection 130 (e.g., a wired Ethernet connection). Although FIG. 1 only shows two modem/gateway devices 100, 200 and one client device 300, any number of modem/gateway devices, and any number of client devices may be included in the network.

In FIG. 1, the operator 500 may include network equipment, (e.g., cable modem termination system, headend hardware, etc.), of a cable television provider, a satellite television provider, an Internet service provider (ISP), telco or multiple systems operator (MSO). The connection 450, the Internet 400, and the connection 150, between the operator 500 and the first modem/gateway device 100 can be considered as encompassing and including any of a WAN, a virtual private network (VPN), metropolitan area networks (MANs), system area networks (SANs), a Data Over Cable Service Interface Specification (DOCSIS) network, a media over coax (MoCA) network, a fiber optics network (such as FTTH (fiber to the home) or FTTX (fiber to the x)), a hybrid fiber coaxial (HFC) network, a public switched data network (PSDN), a global Telex network, a digital subscriber line (DSL), or a wireless broadband system such as a 2G, 3G, 4G or 5G network, for example.

The first modem/gateway device 100 is a hardware electronic device that is capable of acting as a modem for providing content received from the operator 500 to network devices (e.g., client device 300) in one or more wireless networks via connection 130. In the embodiment shown in FIG. 1, the WAN connection 150 is turned off and the first modem/gateway device 100 is locally connected to the second modem/gateway 200 (e.g., by a Wi-Fi connection or a wired Ethernet connection) and the client device 300 (e.g., by a wired Ethernet connection) for synchronization. It is also contemplated by the present disclosure that the first modem/gateway device 100 can be, but is not limited to, an Internet Protocol/Quadrature Amplitude Modulator (IP/QAM) set-top box (STB) or smart media device (SMD) that is capable of decoding audio/video (A/V) content, and playing over-the-top (OTT) or MSO provided content.

The second modem/gateway device 200 is a hardware electronic device that is capable of acting as a modem for providing content received from the operator 500 to network devices (e.g., client device 300) in one or more wireless networks via connection 230. In the embodiment shown in FIG. 1, the second modem/gateway device 200 does not act a modem for the client device 300 but is locally connected to the first modem/gateway 100 for synchronization. However, the second modem/gateway device 200 is capable of being connected to the operator 500 via a WAN connection 250. The WAN connection 250 would constructively provide access to the Internet 400. In FIG. 1, the WAN connection 250 and connection 230 are turned off. It is also contemplated by the present disclosure that the second modem/gateway device 200 can be, but is not limited to, an IP/QAM STB or SMD that is capable of decoding A/V content, and playing OTT or MSO provided content. In an exemplary implementation, the first modem/gateway device 100 establishes a WLAN for communication using, e.g., Wi-Fi, for communication with the second modem/gateway device 200. Accordingly, connection 120 between the first modem/gateway device 100 and the second modem/gateway device 200 may be implemented through a wireless connection such as a Wi-Fi connection. For example, the first modem/gateway device 100 can operate in access point (AP) mode and the second modem/gateway device 200 can operate in client (STA) mode whereby the wireless connection is established. As shown in FIG. 1, the first modem/gateway device 100 may establish a WLAN for communication using, e.g., Wi-Fi, with the second modem/gateway device 200 even when the WAN connection 150 is turned off. Alternatively, connection 120 between the first modem/gateway device 100 and the second modem/gateway device 200 may be implemented through a wired Ethernet connection. For example, an Ethernet cable may be plugged into the LAN side of the first modem/gateway device 100 and the LAN side of the second modem/gateway device 200.

The client device 300 is, for example, any computer, appliance, smart speaker, Internet of Things (IoT) device, iControl device, or other wireless consumer electronic device capable of executing and displaying the content received through, for example, the first modem/gateway device 100. As shown in FIG. 1, for the purpose of accessing the GUI of the first modem/gateway device 100 when the WAN connection 150 is turned off, connection 130 between the first modem/gateway device 100 and the client device 300 may be implemented through a wired Ethernet connection. For example, an Ethernet cable may be plugged into the LAN side of the first modem/gateway device 100 and the LAN side of the client device 300. In other implementations, such as normal operation, the first modem/gateway device 100 establishes a WLAN for communication using, e.g., Wi-Fi, for communication with the client device 300 whereby the first modem/gateway device 100 can allow not only the first modem/gateway device 100 to access the Internet 400, but can also allow the client device 300 to access the Internet 400 via the WLAN established by the first modem/gateway device 100.

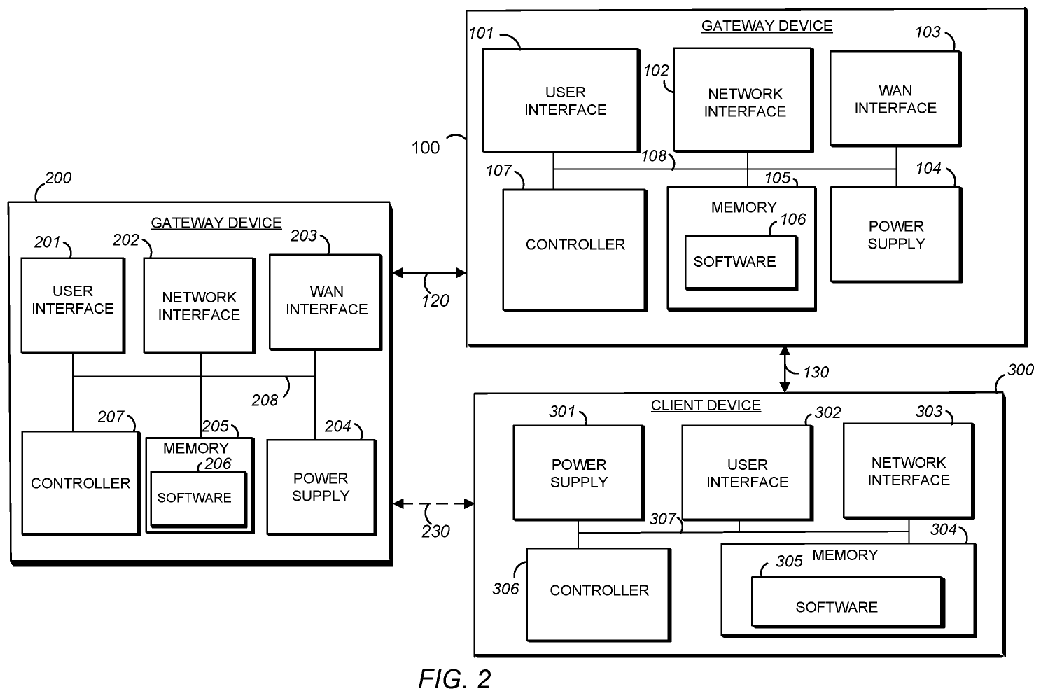

FIG. 2 is a schematic diagram of a system for synchronizing a user configuration of settings between different electronic devices (e.g., first and second modem/gateway devices) according to an embodiment of the present disclosure. As shown in FIG. 1, the system includes a first modem/gateway device 100 normally connected to an operator 500 via a WAN connection 150 which constructively provides access to the Internet 400. The first modem/gateway device 100 is also connected to a second modem/gateway device 200 and a client device 300.

A detailed description of the exemplary internal components of the first modem/gateway device 100, the second modem/gateway device 200, and the client device 300 shown in FIG. 1 will be provided in the discussion of FIG. 2. However, in general, it is contemplated by the present disclosure that the first modem/gateway device 100, the second modem/gateway device 200, and the client device 300 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the first modem/gateway device 100, the second modem/gateway device 200, and the client device 300 may be adapted to execute any operating system, including Linux, UNIX, Windows, MacOS, DOS, and Chrome OS as well as virtual machines adapted to virtualize execution of a particular operating system, including customized and proprietary operating systems. The first modem/gateway device 100, the second modem/gateway device 200, and the client device 300 are further equipped with components to facilitate communication with other computing devices over the one or more network connections to local and wide area networks, wireless and wired networks, public and private networks, and any other communication network enabling communication in the system.

FIG. 2 illustrates a more detailed schematic diagram of the first modem/gateway device 100, the second modem/gateway device 200, and the client device 300 in the system for synchronizing a user configuration of settings between different electronic devices according to an embodiment of the present disclosure.

Now referring to FIG. 2 (e.g., from left to right), the second modem/gateway device 200 is a hardware electronic device that is capable of acting as a modem for providing content received from a WAN interface 203 to devices in a wireless network. As shown in FIG. 2, the second modem/gateway device 200 includes a user interface 201, a network interface 202, the WAN interface 203, a power supply 204, a memory 205, and a controller 207.

The network interface 202 may include various network cards, and circuitry implemented in software and/or hardware to enable communications with the first modem/gateway device 100 using connection 120 (or in embodiments not shown, communications with the client device 300 using connection 230). The various network cards, interfaces, and circuitry of the network interface 202 enable communications via connection 120 to the first modem/gateway device 100 using a wireless protocol that operates in accordance with, but is not limited to, any IEEE 802.11 protocol.

The WAN interface 203 may include various network cards, and circuitry implemented in software and/or hardware to enable communications with operator network 150 (not shown). The various network cards, interfaces, and circuitry of the network interface 202 enable communications to be routed to the Internet via WAN interface 203.

The memory 205 includes a single memory or one or more memories or memory locations that include, but are not limited to, RAM, DRAM, a memory buffer, a hard drive, a database, an EPROM, an EEPROM, ROM, flash memory, logic blocks of a FPGA, a hard disk or any other various layers of memory hierarchy. The memory 205 can be used to store any type of instructions including software 206 associated with algorithms, processes, or operations for controlling the general functions and operations of the second modem/gateway device 200 for synchronizing a user configuration of settings between the first and second modem/gateway devices 100, 200.

The controller 207 controls the general operations of the second modem/gateway device 200 and includes, but is not limited to, a CPU, a hardware processor such as a microprocessor, a multi-core processor, a single core processor, a FPGA, a microcontroller, an ASIC, a DSP, or other similar processing device capable of executing any type of instructions, algorithms, or software for controlling the operation and performing the functions of the second modem/gateway device 200. Communication between the components (e.g., 201-205 and 207) of the second modem/gateway device 200 may be established using an internal bus 208.

The first modem/gateway device 100 is a hardware electronic device that is capable of acting as a modem for providing content received from a WAN interface 103 to the devices (e.g., client device 300) in a wireless network using connection 130. As shown in FIG. 2, the first modem/gateway device 100 includes a user interface 101, a network interface 102, the WAN interface 103, a power supply 104, a memory 105, and a controller 107.

The network interface 102 may include various network cards, and circuitry implemented in software and/or hardware to enable communications with the second modem/gateway device 200 using connection 120 and communications with the client device 300 using connection 130. The various network cards, interfaces, and circuitry of the network interface 102 enable the first modem/gateway device 100 to establish a WLAN for communication with the second modem/gateway device 200 or the client device 300. Accordingly, connection 120 between the first modem/gateway device 100 and the second modem/gateway device 200 may be implemented through a wireless connection such as a Wi-Fi connection. Alternatively, connection 120 between the first modem/gateway device 100 and the second modem/gateway device 200 may be implemented through a wired Ethernet connection. When the WAN connection 150 is disabled, connection 130 between the first modem/gateway device 100 and the client device 300 may be implemented through a wired Ethernet connection. In other implementations, such as normal operation, the first modem/gateway device 100 establishes a WLAN for communication using, e.g., Wi-Fi, for communication with the client device 300 whereby the first modem/gateway device 100 can allow not only the first modem/gateway device 100 to access the Internet 400, but can also allow the client device 300 to access the Internet 400 via the WLAN established by the first modem/gateway device 100.

The WAN interface 103 may include various network cards, and circuitry implemented in software and/or hardware to enable communications with operator network 150 (not shown). The various network cards, interfaces, and circuitry of the network interface 102 enable communications to be routed from network interfaces 202 and 303 to the Internet 400 via WAN interface 103.

The memory 105 includes a single memory or one or more memories or memory locations that include, but are not limited to, RAM, DRAM, a memory buffer, a hard drive, a database, an EPROM, an EEPROM, ROM, flash memory, logic blocks of a FPGA, a hard disk or any other various layers of memory hierarchy. The memory 105 can be used to store any type of instructions including software 106 associated with algorithms, processes, or operations for controlling the general functions and operations of the first modem/gateway device 100 for synchronizing a user configuration of settings between the first and second modem/gateway devices 100, 200.

The controller 107 controls the general operations of the first modem/gateway device 100 and includes, but is not limited to, a CPU, a hardware processor such as a microprocessor, a multi-core processor, a single core processor, a FPGA, a microcontroller, an ASIC, a DSP, or other similar processing device capable of executing any type of instructions, algorithms, or software for controlling the operation and performing the functions of the first modem/gateway device 100. Communication between the components (e.g., 101-105 and 107) of the first modem/gateway device 100 may be established using an internal bus 108.

The client device 300 includes, for example, a smart phone, a computer, an appliance, a smart speaker, an IoT device, an iControl device, or other wireless consumer electronic device capable of executing and displaying the content received through the first modem/gateway device 100. As shown in FIG. 2, the client device 300 includes a power supply 301, a user interface 302, a network interface 303, a memory 304, and a controller 306. The power supply 301 supplies power to the internal components of the client device 300 through an internal bus 307. The power supply 301 can be a self-contained power source such as a battery pack with an interface to be powered through an electrical charger connected to an outlet (e.g., either directly or by way of another device).

The network interface 303 may include various network cards, interfaces, and circuitry implemented in software and/or hardware to enable communications with the first modem/gateway device 100 via connection 130 using a wireless protocol.

Additionally, the various network cards, interfaces, and circuitry of the network interface 303 enable communications via connection 130 using a wireless connection that operates in accordance with, but is not limited to, IEEE 802.11 protocol, RF4CE protocol, ZigBee protocol, Z-Wave protocol, or IEEE 802.15.4 protocol.

As shown in FIG. 1, for the purpose of accessing the GUI of the first modem/gateway device 100 when the WAN connection 150 is turned off, connection 130 between the first modem/gateway device 100 and the client device 300 may be implemented through a wired Ethernet connection.

The memory 304 includes a single memory or one or more memories or memory locations that include, but are not limited to RAM, DRAM, a memory buffer, a hard drive, a database, an EPROM, an EEPROM, ROM, flash memory, logic blocks of a FPGA, a hard disk or any other various layers of memory hierarchy. The memory 304 can be used to store any type of instructions including software 305 associated with algorithms, processes, or operations for controlling the general functions and operations of the client device 300 and synchronizing a user configuration of settings between the first and second modem/gateway devices 100, 200.

The controller 306 controls the general operations of the client device 300 and includes, but is not limited to, a CPU, a hardware processor such as a microprocessor, a multi-core processor, a single core processor, a FPGA, a microcontroller, an ASIC, a DSP, or other similar processing device capable of executing any type of instructions, algorithms, or software for controlling the operation and performing the functions of the client device 300. Communication between the components (e.g., 301-304 and 306) of the client device 300 may be established using an internal bus 307.

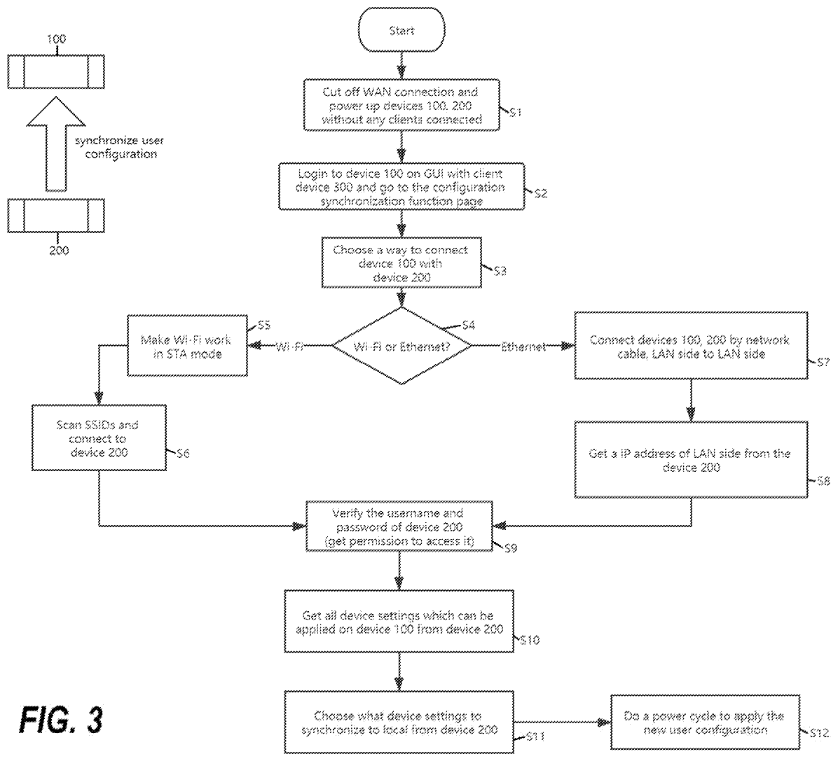

FIG. 3 illustrates an exemplary method and algorithm for synchronizing a user configuration of settings between the first and second modem/gateway devices 100, 200 according to an embodiment of the present disclosure. It is assumed that the first modem/gateway device 100, the second modem/gateway device 200 and the client device 300 include their respective software 106, 206, 305 in their respective memories 105, 205, 304. In FIG. 3, the method and algorithm illustrate operations performed by processors running the software 106 of the first modem/gateway device 100, the software 206 of the second modem/gateway device 200 and the software 305 of the client device 200 synchronizing a user configuration of settings between the first and second modem/gateway devices 100, 200. The software 106, 206, 305 in the respective memories 105, 205, 304 can be for implementing, for example, a procedure between the first modem/gateway device 100 and the second modem/gateway device 200 for synchronizing a user configuration of settings between the first and second modem/gateway devices 100, 200.

In the method and algorithm shown in FIG. 3, a user configuration of device settings is synchronized from the second modem/gateway device 200 (e.g., older modem) to the first modem/gateway device 100 (e.g., newer modem). It is contemplated by the present disclosure that a GUI, a connection daemon and a configuration parser are provided.

In Step S1, a WAN connection (e.g., 150 or 250) is terminated and each of the first modem/gateway device 100 and the second modem/gateway device 200 is powered up so as to be working offline without any client devices connected.

In Step S2, the GUI of the first modem/gateway device 100 is logged into using the client device 300 and a configuration synchronization function page of the GUI is opened. The GUI provides a step-by-step guide to help complete the user configuration synchronization.

In Step S3, a type of connection (e.g., Wi-Fi connection or wired Ethernet connection) to be made between the first modem/gateway device 100 and the second modem/gateway device 200 is selected.

In Step S4, it is determined whether Wi-Fi or Ethernet has been selected as the type of connection. If Wi-Fi has been selected, the process proceeds to Step S5. If Ethernet has been selected, the process proceeds to Step S7.

In Step S5, the mode of the second modem/gateway device 200 is changed from access point mode to client mode. In access point mode (also referred to herein as server mode), other network devices can connect as clients to the second modem/gateway device 200 which acts as a server to provide resources to the clients. In client mode, the second modem/gateway device 200 can connect as a client to the first modem/gateway device 100 which acts as a server.

In Step S6, the GUI is used to scan for SSIDs which the first modem/gateway device 100 can detect, and a connection is established between the first modem/gateway device 100 and the second modem/gateway device 200. The process then proceeds to Step S9.

In Step S7, a wired Ethernet connection is initiated between the first modem/gateway device 100 and the second modem/gateway device 200. For example, an Ethernet cable may be plugged into the LAN side of the first modem/gateway device 100 and the LAN side of the second modem/gateway device 200.

In Step S8, an IP address of the LAN side of the second modem/gateway device 200 is obtained, and a connection is established between the first modem/gateway device 100 and the second modem/gateway device 200. The process then proceeds to Step S9.

In Step S9, a login dialog is provided to verify if there is permission to access the second modem/gateway device 200. For example, a prompt is generated on the GUI which requires the entry of credentials such as a username and a password for the second modem/gateway device 200. If the credentials are correctly entered, the process proceeds to Step S10.

In Step S10, a prior user configuration of the second modem/gateway device 200 is obtained and all compatible device settings between the first modem/gateway device 100 and the second modem/gateway device 200 are obtained. A configuration parser program is run to parse the device settings of the second modem/gateway device 200. The configuration parser program identifies device settings of the second modem/gateway device 200, parses and analyzes the device settings of the second modem/gateway device 200 to determine which of the device settings of the second modem/gateway device 200 are supported or compatible between the first modem/gateway device 100 and the second modem/gateway device 200. Subsequently, the parsed device settings of the second modem/gateway device 200 are converted to local settings of the first modem/gateway device 100. The device settings may include, for example, an SSID setting, a DDNS setting, a parental control setting, a Wi-Fi setting or a firewall setting.

In Step S11, the parsed device settings are presented on the GUI for selection of the parsed device settings that should be imported into the first modem/gateway device 100. For example, each of the device settings may be presented alongside a checkbox and certain device settings can be checked (i.e., automatically designated for import) by default. Other device settings can be selected for import by, for example, clicking ‘Next’ to initiate the new user configuration and the synchronization. In some implementations, all compatible device settings may be automatically imported into the first modem/gateway device 100 without specific input on the GUI.

In Step S12, the first modem/gateway device 100 is rebooted (i.e., a power cycle is performed) so as to implement the new user configuration.

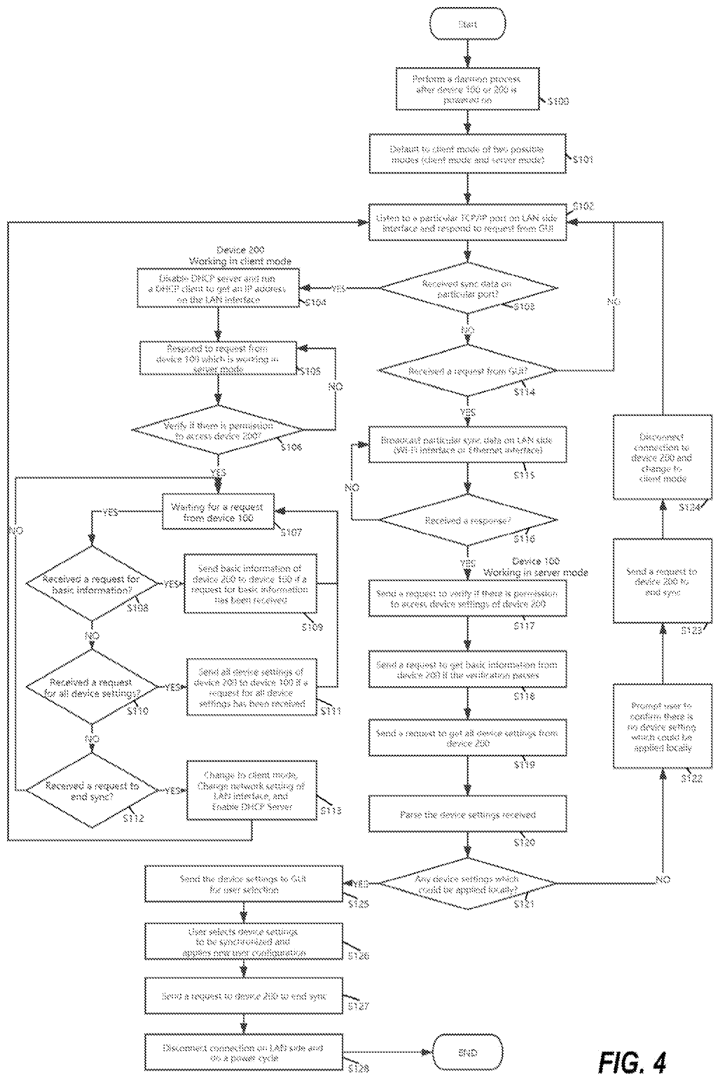

In FIG. 4, the method and algorithm illustrate background operations performed by the software 106 of the first modem/gateway device 100 and the software 206 of the second modem/gateway device 200 for synchronizing a user configuration of settings between the first and second modem/gateway devices 100, 200 according to an embodiment of the present disclosure. The software 106, 206, 305 in the respective memories 105, 205, 304 can be for implementing, for example, a procedure between the first modem/gateway device 100 and the second modem/gateway device 200 for synchronizing at least one device setting between the first modem/gateway device 100 and the second modem/gateway device 200.

In the exemplary method and algorithm of FIG. 4, the synchronizing at least one device setting between the first modem/gateway device 100 and the second modem/gateway device 200 is performed automatically with input from the GUI on the client device 300 by using the software 305 via connection 130. By using the method and algorithm of FIG. 4, at least one device setting can be synchronized between the first modem/gateway device 100 and the second modem/gateway device 200 even if the first modem/gateway device 100 and the second modem/gateway device 200 are different models or of different generations.

In Step S100, each of the first modem/gateway device 100 and the second modem/gateway device 200 is powered on and upon startup a connection daemon (i.e., a computer program that runs as a background process) is launched on each of the first modem/gateway device 100 and the second modem/gateway device 200 for the purpose of monitoring a particular port on a LAN side interface thereof and responding to any request from the GUI of the first modem/gateway device 100.

In Step S101, each of the first modem/gateway device 100 and the second modem/gateway device 200 defaults to client mode whereby the modem/gateway device 100 or 200 can connect as a client to a server.

In Step S102, each of the first modem/gateway device 100 and the second modem/gateway device 200 monitors a particular TCP/IP port on the LAN side interface thereof. For example, the connection daemon can include monitoring software for detecting TCP/IP protocol activities such as active TCP/IP connections, connection resets, connection errors, TCP/IP segments rate, etc. In particular, the monitoring software can detect if a specific TCP/IP port is opened and a TCP/IP connection is established therethrough.

In Step S103, it is determined by the monitoring software whether synchronization (sync) data has been received on the particular TCP/IP port. If sync data has been received, the process proceeds to Step S104. If sync data has not been received, the process proceeds to Step S114.

In Steps S100-S128, the second modem/gateway device 200 is working as a client (i.e., is in client mode). In Steps S100-S103 and S114-S116, the first modem/gateway device 100 is working as a client. In Steps S117-S128, the first modem/gateway device 100 is working as a server (i.e., is in server mode). In Step S113 and/or Step S128, the first modem/gateway device 100 may return to client mode as discussed below.

In Step S104, a local Dynamic Host Configuration Protocol (DHCP) server which automatically provides private IP addresses on the LAN side to clients is disabled and a DHCP client is run to obtain an IP address from the server and reconfigure the LAN interface of the second modem/gateway device 200 to have a different IP address than the original static IP address of the LAN interface of the second modem/gateway device 200. Accordingly, a TCP/IP connection between the first modem/gateway device 100 and the second modem/gateway device 200 is established.

In Step S105, the second modem/gateway device 200 responds to a request from the first modem/gateway device 100 with respect to device settings of the second modem/gateway (see also Step S117). For example, the user configuration synchronization may be initiated from the GUI of the first modem/gateway device 100.

In Step S106, the second modem/gateway device 200 verifies if there is permission to access the contents of the second modem/gateway device 200 (see also Step S9 in FIG. 3). If the verification step fails, the process returns to Step S105. If the verification step passes, the process proceeds to Step S107.

In Step S107, the second modem/gateway device 200 is standing by and waiting for any request to be transmitted from the first modem/gateway device 100. Once a request is received, the second modem/gateway device 200 determines in Step S108, Step S110 and/or Step S112 what the requested action is and responds accordingly in Step S109, Step S111 or Step S113.

In Step S108, it is determined if a request for basic information (of the second modem/gateway device 200) has been received from the first modem/gateway device 100 (see also Step S118). If a request for basic information has been received, the process proceeds to Step S109. If a request for basic information has not been received, the process proceeds to Step S110.

In Step S109, basic information of the second modem/gateway device 200 is sent to the first modem/gateway device 100. For example, the basic information of the second modem/gateway device 200 can include the model, type, name, hardware version, firmware version, serial number, certificate, Media Access Control (MAC) address, format, etc. The process then returns to Step S107.

In Step S110, it is determined if a request for all device settings (of the second modem/gateway device 200) has been received from the first modem/gateway device 100 (see also Step S119). If a request for all device settings has been received, the process proceeds to Step S111. If a request for all device settings has not been received, the process proceeds to Step S112.

In Step S111, all device settings of the second modem/gateway device 200 are sent to the first modem/gateway device 100. For example, all devices settings included in a modem capability database (modemcap) can be transmitted. A modemcap is a database which can include setup strings or modem configuration commands used to change default settings of the modem/gateway device. The process then returns to Step S107.

In Step S112, it is determined if a request to end synchronization has been received from the first modem/gateway device 100 (see also Step S123 or Step S127). If a request for to end synchronization has been received, the process proceeds to Step S113. If a request to end synchronization has not been received, the process returns to Step S107.

In Step S113, the mode of the first modem/gateway device 100 is changed from server mode to client mode, the IP address of the second modem/gateway device 200 is changed back to the original static IP address of the LAN interface of the second modem/gateway device 200, and the DHCP server is enabled. The process then returns to Step S102.

In Step S114, it is determined if a request from the GUI of the first modem/gateway device 100 has been received by the first modem/gateway device 100. If a request from the GUI has not been received, the process returns to Step S102. If a request from the GUI has been received, the process proceeds to Step S115 and the mode of the first modem/gateway device 100 is changed from client mode to server mode.

In Step S115, particular sync data is broadcast on the LAN side (either via the Wi-Fi interface or the Ethernet interface) by the first modem/gateway device 100.

In Step S116, it is determined if a response to the sync data broadcast has been received from the second modem/gateway device 200. If a response to the sync data broadcast has not been received, the process returns to Step S115. If a response to the sync data broadcast has been received, the process proceeds to Step S117.

In Step S117, the first modem/gateway device 100 sends a request to the second modem/gateway device 200 to verify if there is permission to access device settings of the second modem/gateway device 200. For example, credentials (such as a username and a password for the second modem/gateway device 200) can be entered in a login dialog providing a prompt generated on the GUI (see also Step S106).

In Step S118, after the verification step has passed, the first modem/gateway device 100 sends a request to the second modem/gateway device 200 to obtain basic information of the second modem/gateway device (see also Step S108).

In Step S119, the first modem/gateway device 100 sends a request to the second modem/gateway device 200 to obtain a prior user configuration of all device settings of the second modem/gateway device 200 (see also Step S110).

In Step S120, a configuration parser program is run to parse the device settings of the second modem/gateway device 200. The configuration parser program identifies, parses and analyzes the device settings of the second modem/gateway device 200 to determine which of the device settings of the second modem/gateway device 200 are compatible between the first modem/gateway device 100 and the second modem/gateway device 200.

In Step S121, it is determined if any of the parsed device settings are compatible between the first modem/gateway device 100 and the second modem/gateway device 200. If no, the process proceeds to Step S122. If yes, the process proceeds to Step S125.

In Step S122, a dialog is provided to confirm that none of the device settings of the second modem/gateway device 200 can be applied locally on the first modem/gateway device 100. For example, a prompt is generated on the GUI which requires confirmation of incompatibility of all devices settings of the second modem/gateway device 200.

In Step S123, the first modem/gateway device 100 sends a request to the second modem/gateway device 200 to end synchronization (see also Step S112).

In Step S124, the TCP/IP connection between the first modem/gateway device 100 and the second modem/gateway device 200 is terminated and the mode of the first modem/gateway device 100 is changed from server mode to client mode. The process then returns to Step S102.

In Step S125, the parsed device settings are presented on the GUI for selection of the parsed device settings that should be imported into the first modem/gateway device 100. For example, each of the device settings may be presented alongside a checkbox and certain device settings can be checked (i.e., automatically designated for import) by default.

In Step S126, the device settings to be imported are selected and the new user configuration and the synchronization are initiated (see also Step S11 in FIG. 3). In some implementations, all compatible device settings may be automatically imported into the first modem/gateway device 100 without specific input on the GUI.

In Step S127, the first modem/gateway device 100 sends a request to the second modem/gateway device 200 to end synchronization (see also Step S112).

In Step S128, the TCP/IP connection between the first modem/gateway device 100 and the second modem/gateway device 200 is terminated and the first modem/gateway device 100 is rebooted (i.e., a power cycle is performed) so as to implement the new user configuration (see also Step S12 in FIG. 3). The process then ends.

The present disclosure may be implemented as any combination of an apparatus, a system, an integrated circuit, and a computer program on a non-transitory computer readable recording medium. The one more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIGS. 3 and 4. For example, the one or more memories store software or algorithms with executable instructions and the one or more processors can execute a set of instructions of the software or algorithms in association with synchronizing a user configuration of settings between different electronic devices such as modem or gateway devices.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

We claim:

1. A method for synchronizing at least one device setting between a first gateway device and a second gateway device, the method comprising:
accessing a graphical user interface (GUI) for the first gateway device on a client device;
establishing a network connection between the first gateway device and the second gateway device;
obtaining a prior user configuration of device settings from the second gateway device;
parsing the device settings of the second gateway device;
selecting, via the GUI for the first gateway device, at least one of the device settings of the second gateway device to obtain a new user configuration; and
transmitting the new user configuration to the first gateway device for implementation.

2. The method according to claim 1, further comprising selecting, via the GUI for the first gateway device, a type of the network connection.

3. The method according to claim 1, wherein the network connection is a Wi-Fi connection.

4. The method according to claim 3, wherein the establishing the network connection between the first gateway device and the second gateway device includes scanning for a service set identifier (SSID).

5. The method according to claim 1, wherein the network connection is a wired Ethernet connection.

6. The method according to claim 5, wherein the establishing the network connection between the first gateway device and the second gateway device includes obtaining an Internet Protocol (IP) address.

7. The method according to claim 5, wherein the first gateway device is a different model or of a different generation than the second gateway device.

8. The method according to claim 1, further comprising verifying permission to access the second gateway device.

9. The method according to claim 1, further comprising rebooting the first gateway device.

10. The method according to claim 1, wherein the device settings include at least one of an SSID setting, a Dynamic Domain Name Server (DDNS) setting, a parental control setting, a Wi-Fi setting or a firewall setting.

11. A non-transitory computer-readable recording medium for synchronizing at least one device setting between a first gateway device and a second gateway device, the non-transitory computer-readable recording medium storing one or more programs which when executed by a hardware processor performs steps comprising:
accessing a graphical user interface (GUI) for the first gateway device on a client device;
establishing a network connection between the first gateway device and the second gateway device;
obtaining a prior user configuration of device settings from the second gateway device;
parsing the device settings of the second gateway device;
selecting, via the GUI for the first gateway device, at least one of the device settings of the second gateway device to obtain a new user configuration; and
transmitting the new user configuration to the first gateway device for implementation.

12. The non-transitory computer-readable recording medium according to claim 11, wherein the one or more programs when executed by the hardware processor performs a further step of selecting, via the GUI for the first gateway device, a type of the network connection.

13. The non-transitory computer-readable recording medium according to claim 11, wherein the network connection is a Wi-Fi connection.

14. The non-transitory computer-readable recording medium according to claim 13, wherein the establishing the network connection between the first gateway device and the second gateway device includes scanning for a service set identifier (SSID).

15. The non-transitory computer-readable recording medium according to claim 11, wherein the network connection is a wired Ethernet connection.

16. The non-transitory computer-readable recording medium according to claim 15, wherein the establishing the network connection between the first gateway device and the second gateway device includes obtaining an Internet Protocol (IP) address.

17. The non-transitory computer-readable recording medium according to claim 11, wherein the first gateway device is a different model or of a different generation than the second gateway device.

18. The non-transitory computer-readable recording medium according to claim 11, wherein the one or more programs when executed by the hardware processor performs a further step of verifying permission to access the second gateway device.

19. The non-transitory computer-readable recording medium according to claim 11, wherein the one or more programs when executed by the hardware processor performs a further step of rebooting the first gateway device.

20. The non-transitory computer-readable recording medium according to claim 11, wherein the device settings include at least one of an SSID setting, a Dynamic Domain Name Server (DDNS) setting, a parental control setting, a Wi-Fi setting or a firewall setting.
